(19) United States
(12) Patent Application Publication
(10) Pub. No.: US 2025/0028845 A1
(43) Pub. Date: Jan. 23, 2025

(54) Secret Replacement for Web Browsers

(71) Applicant: CyberArk Software Ltd., Petach-Tikva (IL)

(72) Inventors: Anatoly KARDASH, Petach-Tikva (IL); Michael YAVNILOVICH, Petach-Tikva (IL); Dima BARBOI, Petach-Tikva (IL); Boris SPIVAK, Petach-Tikva (IL)

(73) Assignee: CyberArk Software Ltd., Petach-Tikva (IL)

(21) Appl. No.: 18/398,644

(22) Filed: Dec. 28, 2023

Related U.S. Application Data
(60) Provisional application No. 63/503,482, filed on May 21, 2023.

(51) Int. Cl. G06F 21/60

(52) U.S. Cl. CPC G06F 21/604

(57) ABSTRACT

Disclosed embodiments relate to systems and methods for replacing secrets for use with browser components. Techniques include requesting, by a secret management application running in conjunction with a browser component, a genuine secret; sending, to a secret consuming application, a replacement secret in lieu of the genuine secret, wherein the replacement secret is provided from a secret replacement module that has determined that the genuine secret should be replaced and has intercepted a transmission of the genuine secret from the secret management application to the secret consuming application; and enabling the secret consuming application to utilize the replacement secret to attempt to perform a secured action, wherein the secret replacement module intercepts the attempt and replaces the replacement secret with the genuine secret to complete the attempt.

### CROSS-REFERENCE TO RELATED APPLICATION

This application claims the benefits of priority to U.S. Provisional Application No. 63/503,482, filed on May 21, 2023, the entirety of which is incorporated herein by reference.

### BACKGROUND

### Technical Field

The present disclosure relates generally to secure browsers. In some embodiments, this disclosure relates to systems and methods for replacing secrets for use with browser components.

### Background Information

In modern computing environments, highly sensitive data is often transferred between network identities and various resources, such as web-based applications. This data may include secrets (a private piece of information that acts as a key to unlock protected resources or data, e.g., credentials, certificates, keys, tokens, hashes, or any other type of sensitive data required to perform a sensitive operation, such as authentication and authorization processes). Such secrets may be used by network identities, for example, to login to various web-based applications, cloud-based applications, and/or operating system applications.

A common practice is to store secrets in a dedicated application (e.g., a web browser, a web browser's add-on or extension, or another application) that is configured to store and manage the secrets on demand, such as secret providers or password managers. The stored secrets may be transferred from such applications to a corresponding application that requires or utilizes a secret-based action, e.g., login, authentication, authorization, approval, access, control, etc. One example is a secret that is “copy-pasted” from a secret manager or the operating system's buffer for short-term storage (e.g., in a “clipboard”), and from there to the web application.

In some environments, web browsers may prompt or require users or identities to login via an identity provider (e.g., the CyberArk Identity Security Platform™, AWS™ IAM, Azure™ IAM, or others). Before the user or identity is authenticated, it may be blocked or prohibited from browsing via the browser (e.g., blocked to access the Internet, an intranet environment, or another network). Browsers may be installed or configured for individual users discretely, for tenants or users, or for other groups of users (e.g., based on group definitions). Further, an installation parameter may be provided (e.g., on a per-user basis, per-group basis, per-tenant basis, etc.).

Plain-text secrets stored in an unprotected memory region are exposed and vulnerable, and may, for example, be viewed or exfiltrated by malicious actors. If the secret is stored, for example, in an operating system's buffer memory (e.g., clipboard, or memory section dedicated for short-term storage by the operating system to store and retrieve data within and between applications) a malicious actor may access the secret and may “copy” and “paste” the secret into any application. Also, the secret may be accessed through an application programming interface (API) by any application, including malicious applications (e.g., malware or the like).

Therefore, there is a need for solutions that are not so easily accessible but still allow a user to quickly access information via a web browser. The disclosed systems and methods address these security vulnerabilities without degrading network communications, application performance, or user friendliness. Disclosed techniques, for example, may make secrets stored in dedicated applications such as “password managers” inaccessible and even unviewable by the network identity and third parties, while keeping the full functionality and use of secrets to perform sensitive operations such as login, authentication, authorization, approval, access, control, etc., with applications, network resources, and other identities. These and other advantages of the disclosed techniques are discussed below.

### SUMMARY

The disclosed embodiments describe non-transitory computer readable media, systems, and methods for performing operations for replacing secrets for use with browser components. For example, in some embodiments, a non-transitory computer readable medium may include instructions that, when executed by at least one processor, cause the at least one processor to perform operations for replacing secrets for use with browser components. The operations may comprise requesting, by a secret management application running in conjunction with a browser component, a genuine secret, sending, to a secret consuming application, a replacement secret in lieu of the genuine secret, wherein the replacement secret is provided from a secret replacement module that has determined that the genuine secret should be replaced and has intercepted a transmission of the genuine secret from the secret management application to the secret consuming application, and enabling the secret consuming application to utilize the replacement secret to attempt to perform a secured action, wherein the secret replacement module intercepts the attempt and replaces the replacement secret with the genuine secret to complete the attempt.

According to a disclosed embodiment, the secret replacement module is configured to store secrets in a protected manner associated with the browser component.

According to a disclosed embodiment, the protected manner is controlled by an external service or application.

According to a disclosed embodiment, the interception of the genuine secret occurs between the secret management application and the browser component.

According to a disclosed embodiment, the secret replacement module is configured to operate according to one or more configuration parameters.

According to a disclosed embodiment, the secret replacement module is configured to operate according to one or more configuration parameters to determine whether to replace the genuine secret.

According to a disclosed embodiment, the one or more configuration parameters include at least one of: a definition of the secured action, a network resource name, a network resource address of a resource that performs the secured action, or an expiration parameter associated with the genuine secret.

According to a disclosed embodiment, the secured action includes accessing an access-restricted network location.

According to a disclosed embodiment, the one or more configuration parameters include at least one of: a file type, a file name, a file signature, a file path, or a file checksum.

According to a disclosed embodiment, the secured action includes accessing an access-restricted application.

According to further disclosed embodiments, there may be computer-implemented methods for replacing secrets for use with a browser component. The methods may comprise requesting, by a secret management application running in conjunction with a browser component, a genuine secret, sending, to a secret consuming application, a replacement secret in lieu of the genuine secret, wherein the replacement secret is provided from a secret replacement module that has determined that the genuine secret should be replaced and has intercepted a transmission of the genuine secret from the secret management application to the secret consuming application, and enabling the secret consuming application to utilize the replacement secret to attempt to perform a secured action, wherein the secret replacement module intercepts the attempt and replaces the replacement secret with the genuine secret to complete the attempt.

According to a disclosed embodiment, the secret management application is integrated into the browser component.

According to a disclosed embodiment, the request by the secret management application prompts the browser component to make a corresponding request for the genuine secret.

According to a disclosed embodiment, the secret management application is a module distinct from the browser component.

According to a disclosed embodiment, the browser component is a part of a web browser.

According to a disclosed embodiment, the browser component is a web browser plug-in.

According to a disclosed embodiment, the secret replacement module is configured to store the genuine secret in a protected manner.

According to a disclosed embodiment, the secret replacement module is configured to discard the genuine secret based on at least one of: a time parameter or a usage parameter.

According to a disclosed embodiment, the secret replacement module is configured to generate the replacement secret on a just-in-time basis.

According to a disclosed embodiment, the secret replacement module is configured to generate the replacement secret according to a least-privilege principle.

According to a disclosed embodiment, the secret replacement module is configured to decommission the replacement secret when it is no longer necessary.

Aspects of the disclosed embodiments may include tangible computer-readable media that store software instructions that, when executed by one or more processors, are configured for and capable of performing and executing one or more of the methods, operations, and the like consistent with the disclosed embodiments. Also, aspects of the disclosed embodiments may be performed by one or more processors that are configured as special-purpose processor(s) based on software instructions that are programmed with logic and instructions that perform, when executed, one or more operations consistent with the disclosed embodiments.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 illustrates an example system environment for replacing secrets for use with browser components, consistent with disclosed embodiments.

FIG. 2 is an example secret replacement system environment, consistent with disclosed embodiments.

FIG. 3 illustrates a block diagram of an example server, consistent with disclosed embodiments.

FIG. 4 is a schematic diagram of a distributed system for implementing the disclosed embodiments, consistent with disclosed embodiments.

FIG. 5 is a flowchart showing an example process for replacing secrets for use with browser components, consistent with disclosed embodiments.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence, or constrained to a particular system configuration. Additionally, some of the described embodiments or elements thereof can occur or be performed simultaneously, at the same point in time, or concurrently.

The techniques for replacing secrets for use with browser components described herein overcome several technological problems relating to security, efficiency, and functionality in the fields of cybersecurity and software development. In contrast to prior techniques, the disclosed operations allow for secure communications using web browsers without sensitive secrets being required to be stored by the web browsers (in, for example, a web browser memory, a web browser history, or in an operating system clipboard). The sensitive secrets are also not known to a human user. This significantly limits the vulnerability of secrets to theft and misuse. The disclosed techniques also allow seamless access to secure target destinations. Web browsers are able to access such target destinations even without possessing sensitive secrets themselves and without interruptions in the user experience. These and other technological advantages are described further below.

Reference will now be made in detail to the disclosed embodiments, examples of which are illustrated in the accompanying drawings.

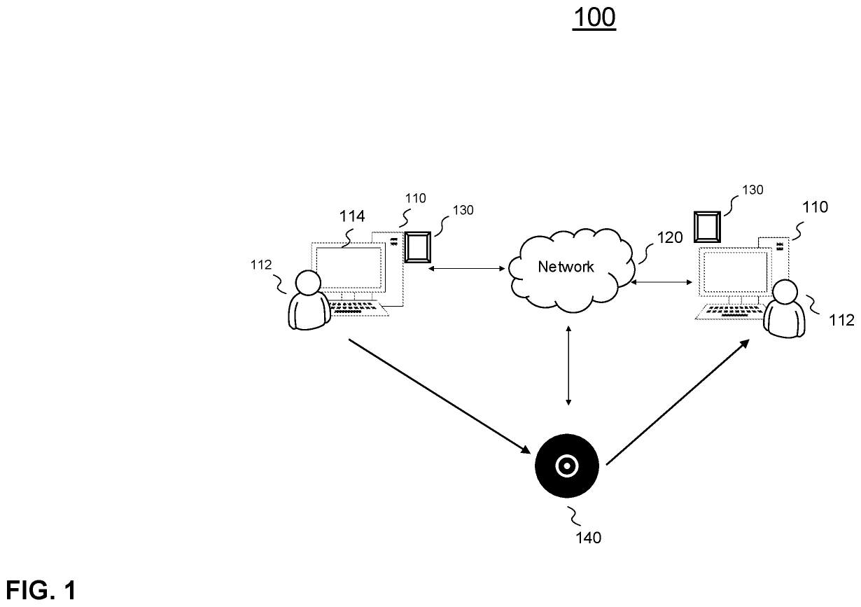

FIG. 1 illustrates an example system environment 100 for replacing secrets for use with browser components. The various components of system 100 may communicate over a network 120. Such communications may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, the communications may take place across two or more of these forms of networks and protocols. While system environment 100 is shown as a network-based environment, it is understood that in some embodiments, one or more aspects of the disclosed systems and methods may also be used in a localized system, with one or more of the components communicating directly with each other.

System 100 may also include browser components 110. Browser components 110 may include a user interface, such as user interface 114, computer data storage, a browser engine, a rendering engine, a secure web browser, a data persistence layer, and any other components necessary to run a web browser. In some embodiments, computer data storage may comprise computer components and recording media that are used to retain digital data. Data may be stored in memory, on servers, or in cloud computing environments. Computer data storage may be managed using the central processing unit of a computer. The browser engine may receive input from a user interface and process it to command a rendering engine. This browser engine may be used to provide an interactive user experience. For example, when a user clicks or selects an element on a user interface, the browser engine ensures that the browser redirects to the clickable element. In some embodiments, the browser engine is an intermediary between the user interface and a rendering engine. The rendering engine is a component responsible for rendering web content, such as HTML, CSS, or JavaScript into a visual display on a user interface. A secure web browser may include a dedicated web browser application or a plug-in (also referred to as an “extension”) to a non-dedicated web browser, having a built-in module performing the disclosed techniques (in some embodiments, in combination with an additional application or process (“agent”) installed or operating in association with the network identity's machine). A data persistence layer may be part of the data storage. The data persistence layer may help a browser to store data locally, such as cookies, local cache, or the like.

System 100 may also include a user interface 114 with which a user 112 may interact. In some embodiments, user interface 114 enables a user 112 to input data to browser components 110. In some embodiments, information inputted to user interface 114 can be in various formats. For example, user interface 114 can include a keyboard, mouse, and a display such that user 112 can type information via a keyboard in a designated area on the display or draw information using the mouse. Activities of user 112 may include taking notes or entering information on user interface 114 in real-time.

System 100 may also include a processor 130, such as used in computer 110 and network components of network 120. Processor 130 may take the form of, but is not limited to, a microprocessor, embedded processor, or the like, or may be integrated in a system on a chip (SoC). Furthermore, according to some embodiments, processor 130 may be from the family of processors manufactured by Intel®, AMD®, Qualcomm®, Apple®, NVIDIA®, or the like. The processor 130 may also be based on the ARM architecture, a mobile processor, or a graphics processing unit, etc.

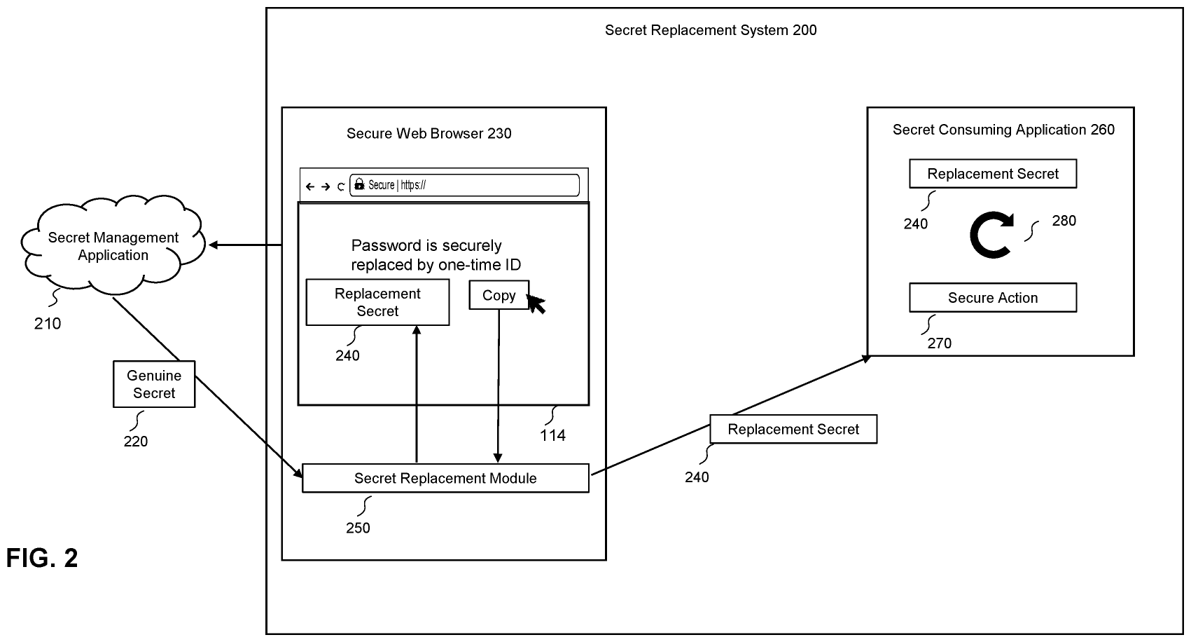

System 100 may also include secret 140. The secret 140 may refer to the genuine secret or the replacement secret, as described with respect to FIG. 2. Examples of secrets may be passwords, credentials, tokens, keys, hashes, or other unique and sensitive data used for authentication, authorization, or other secure access techniques. A replacement secret, as discussed below, may take the place of (or be used instead of) a genuine secret. In some cases, a replacement secret may be formed to match an attribute of the corresponding genuine secret. For example, both may share a common character length, file size, bit length, encryption format, beginning or ending character, or other attribute. In some embodiments, there is a one-to-one relationship between a single genuine secret and a single replacement secret. In further embodiments, there may be a one-to-many, many-to-one, or many-to-many relationship between genuine and replacement secrets.

FIG. 2 is an example secret replacement system environment, consistent with disclosed embodiments. Secret replacement system 200 may comprise secret management application 210, genuine secret 220, secure web browser 230, replacement secret 240, user interface 114, secret replacement module 250, secret consuming application 260, secure action module 270, and interception module 280.

Secret management application 210 may include a buffer memory that operates in conjunction with secure web browser 230 to perform the secret replacement techniques. In some embodiments, secret management application 210 may send the genuine secret 220 to the user interface 114. In further embodiments, the genuine secret 220 may be intercepted by secret replacement module 250 running in secure web browser 230. As discussed below, secret replacement module 250 may decide based on various rules or parameters whether to intercept and replace genuine secret 220. Some such rules or parameters may be stored at secret management application 210. The various rules or parameters may include definitions for a web application (e.g., such as HTTP URLs), definitions of a web application within a secret-based operation, definitions of an operating system (e.g., various attributes of executable files, digital signatures, file paths, or expiration parameters), etc.

Genuine secret 220 may include a secret stored in a dedicated application, such as secret management application 210. Genuine secret 220 may be used to perform sensitive operations such as logging into various web applications (e.g., secret consuming application 260) or operating system (OS) applications, accessing sensitive data, or performing other sensitive operations. In some embodiments, an operating system may require a genuine secret to perform a sensitive operation, such as to authenticate network identities, and may run outside of secure web browser 230 on a local machine. Genuine secret 220 may also be used for authentication, authorization, approval, access, or control with applications, network resources, or other identities. Genuine secret 220 may be, for example, a user and password, an API credential, temporary token, an SSH key, a system-to-system password, a client-side certificate for secure communication, a private encryption key, a one-time password, or another credential of the same type, among other types of secrets.

Secure web browser 230 may be a dedicated web browser application or plug-in, as described with respect to FIG. 1. Secure web browser 230 may require a genuine secret to perform sensitive operations, such as authentication, authorization, login, or control. In some embodiments, secure web browser 230 may comprise a user interface, such as user interface 114. While in some embodiments web browser 230 may be configured to access the entire Internet, in other embodiments web browser 230 may be restricted to certain networks, servers, or other locations. Examples of secure web browser 230 may include, for example, those based on the Chromium open-source browser project, such as Chrome™, Brave™, Microsoft Edge or various proprietary browsers.

Replacement secret 240 may include a temporary replacement of genuine secret 220 to be stored in memory. Replacement secret 240 may be shown in a user interface, such as user interface 114, or transferred between applications and processes, in lieu of the genuine secret 220. In some embodiments, replacement secret 240 may be stored in association with configuration parameters such as time restrictions, user restrictions, target application restrictions, etc. For example, the time restrictions may restrict how many times the replacement secret may be used, an expiry time of the replacement secret, a time of day to use the replacement secret, or any other time-related restrictions. User restrictions may limit what identities are permitted to assert the secret (or have it asserted on their behalf). Target application restrictions may determine which applications (e.g., secret consuming application 260) are permitted to utilize the secret. Other restrictions may include geographic restrictions (e.g., limiting where geographically the user or target application is located), action restrictions (e.g., allowing certain read/write/modify actions), and the like.

Secret replacement module 250 may intercept genuine secret 220. The decision of whether to perform an interception or not may be based on various criteria (e.g., an identity of the user 112, an application running on computer 110, an action requested to be performed, a target resource (e.g., secret consuming application 260) attempted to be accessed, an update to an application running at computer 110, an action within secure web browser 230, etc.). Secret replacement module 250 may be running in secure web browser 230. In some embodiments, a user may be able to copy replacement secret 240 and send it to secret replacement module 250, as shown in FIG. 2. Secret replacement module 250 may check the definition of genuine secret 220 based on configuration parameters to determine whether genuine secret 220 should be replaced. In some embodiments, if secret replacement module 250 determines genuine secret 220 should be replaced, secret replacement module 250 may store the genuine secret 220 in memory and create a replacement secret 240. Secret replacement module 250 may transfer the replacement secret 240 to user interface 114 instead of genuine secret 220. In some embodiments, the genuine secret 220 may not be passed to user interface 114. Instead, replacement secret 240 may be transferred and stored in memory, such as operating system memory. The replacement secret 240 may then be pasted into the user interface of the secure web browser 230 to allow the secret replacement module 250 to retrieve the secret using a copy function.

Secret replacement system 200 may then initiate a secure action, such as a login or authorization. This may include, for example, secure web browser 230 attempting to access secret consuming application 260 or access a resource that requires access to secret consuming application 260. Upon initiating the sensitive operation, secret consuming application 260 may intercept the secret, at interception module 280. Before the secure action 270 (e.g., login, access, read, write, modify, etc.) occurs, the definition of the web application may be checked against the secure action 270 to allow receiving the replacement secret 240 and allow the secure action 270 to occur.

In some embodiments, using the techniques disclosed with respect to FIG. 2, a third party, such as a malicious actor, cannot view or obtain the genuine secret 220 because it does not appear in the user interface 114 and is not stored in memory. The genuine secret 220 may only reside in, e.g., an encrypted network communication and a protected memory region associated with the secret replacement module 250. Even if a malicious actor gains access to secure web browser 230, therefore, they will not necessarily be able to access genuine secret 220. Memory protection methods used by secret replacement module 250 may include encryption, mangling, access restriction (e.g., authentication), or other forms of protection. In some embodiments, the only locations where the genuine secret 220 may reside are the encrypted network communication, the protected memory of the secret replacement module 250, and the memory and user interface of the operating system application (e.g., secret consuming application 260). These techniques allow for secure web browser 230 to securely, efficiently, and seamlessly utilize secrets to access restricted network resources, such as secure applications (e.g., secret consuming application 260), databases, servers, keys, tokens, and files.

Access to secret consuming application 260 may also occur through other methods. For example, access may be granted using a private-public key pair. Access may also be granted using authentication information, such as biometric information. These techniques may be used in lieu of, or in addition to, the secret replacement techniques described above. For example, some secret consuming applications 260 may require two levels or steps of security. A first step may be receiving and processing a genuine secret 220 based on use of a replacement secret 240. A second step may be cryptographic authentication, biometric authentication, challenge prompts, etc.

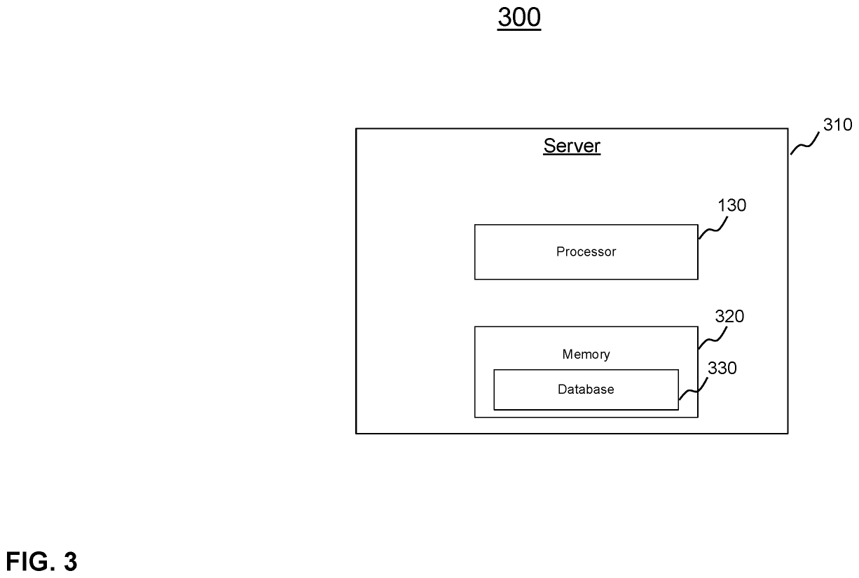

FIG. 3 is a block diagram 300 showing an example server 310, consistent with the disclosed embodiments. Server 310 may be a computing device (e.g., a server, virtual machine, container instance, personal computer, mobile device, IoT device, etc.) and may include one or more associated processors 130 and/or memories 320. Consistent with disclosed embodiments, computer 110, a computer hosting secret management application 210, a computer hosting secret replacement module 250, a computer hosting secure web browser 230, and/or a computer hosting secret consuming application 260 may be implemented in accordance with the elements of FIG. 3.

Processor 130 may take the form of, but is not limited to, a microprocessor, embedded processor, or the like, or may be integrated in a system on a chip (SoC). Furthermore, according to some embodiments, processor 130 may be from the family of processors manufactured by Intel®, AMD®, Qualcomm®, Apple®, NVIDIA®, or the like. The processor 130 may also be based on the ARM architecture, a mobile processor, or a graphics processing unit, etc. The disclosed embodiments are not limited to any type of processor configured in server 310.

Memory 320 may include one or more storage devices configured to store instructions used by the processor 130 to perform functions related to server 310. The disclosed embodiments are not limited to particular software programs or devices configured to perform dedicated tasks. For example, memory 320 may store a single program, such as a user-level application, that performs the functions associated with the disclosed embodiments, or may comprise multiple software programs. Additionally, the processor 130 may, in some embodiments, execute one or more programs (or portions thereof) remotely located from server 310. Furthermore, memory 320 may include one or more storage devices configured to store data for use by the programs. Memory 320 may include, but is not limited to a hard drive, a solid-state drive, a CD-ROM drive, a peripheral storage device (e.g., an external hard drive, a USB drive, etc.), a network drive, a cloud storage device, or any other storage device.

In some embodiments, memory 320 may include a database 330. Database 330 may be included on a volatile or non-volatile, magnetic, semiconductor, tape, optical, removable, non-removable, or other type of storage device or tangible or non-transitory computer-readable medium (e.g., memory 320). Database 330 may also be part of server 310 or separate from server 310. When database 330 is not part of server 310, server 310 may exchange data with database 330 via a communication link. Database 330 may include one or more memory devices that store data and instructions used to perform one or more features of the disclosed embodiments. Database 330 may include any suitable databases, ranging from small databases hosted on a workstation to large databases distributed among data centers. Database 330 may also include any combination of one or more databases controlled by memory controller devices (e.g., server(s), etc.) or software. For example, database 330 may include document management systems, Microsoft SQL™ databases, SharePoint™ databases, Oracle™ databases, Sybase™ databases, other relational databases, or non-relational databases, such as mongo and others.

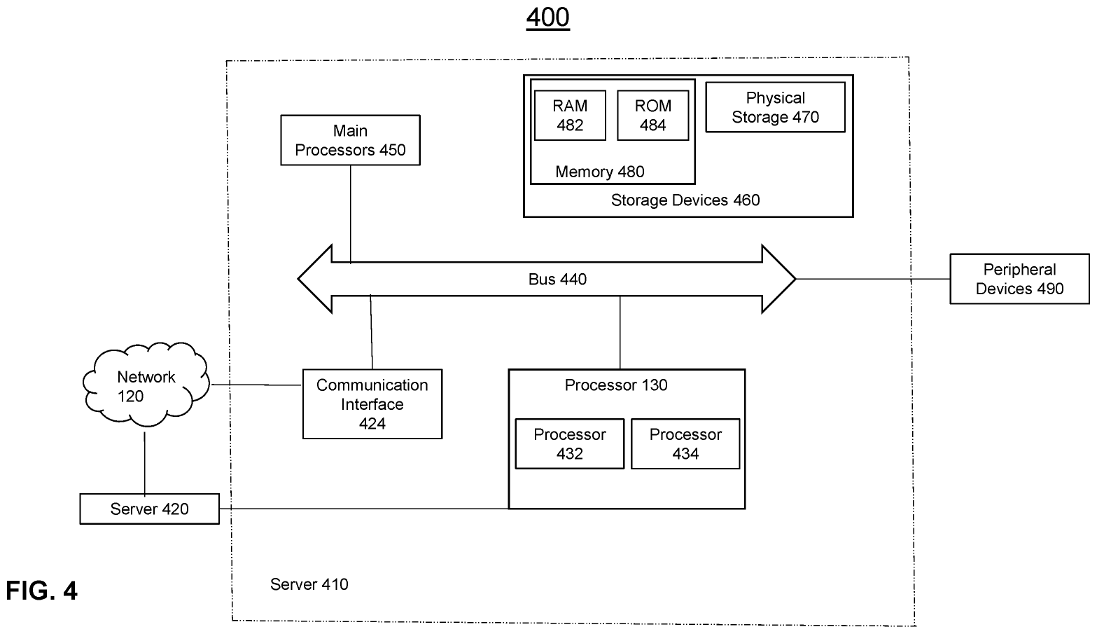

FIG. 4 is a schematic diagram of an exemplary distributed system for implementing embodiments of the present disclosure. According to FIG. 4, server 410 (e.g., similar to server 310) of distributed computing system 400 includes a bus 440 or other communication mechanisms for communicating information, one or more processors 130 communicatively coupled with bus 440 for processing information, and one or more main processors 450 communicatively coupled with bus 440 for processing information. Processors 130 can be, for example, one or more microprocessors. In some embodiments, one or more processors 130 includes processor 432 and processor 434, and processor 432 and processor 434 are connected via an inter-chip interconnect of an interconnect topology. In some embodiments, processor 434 can be a dedicated hardware accelerator (such as a neural network processing unit) for processor 432. Main processors 450 can be, for example, central processing units (“CPUs”).

Server 410 may transmit data to or communicate with another server 420 through a network 120. Network 120 may be a local network, an internet service provider, Internet, or any combination thereof. Communication interface 424 of server 410 is connected to network 120, which may enable communication with server 420 (e.g., also similar to server 310). In addition, server 410 can be coupled via bus 440 to peripheral devices 490, which may include displays (e.g., cathode ray tube (CRT), liquid crystal display (LCD), touch screen, etc.) and input devices (e.g., keyboard, mouse, soft keypad, etc.).

Server 410 may be implemented using customized hard-wired logic, one or more ASICs or FPGAs, firmware, or program logic that in combination with the server causes server 410 to be a special-purpose machine.

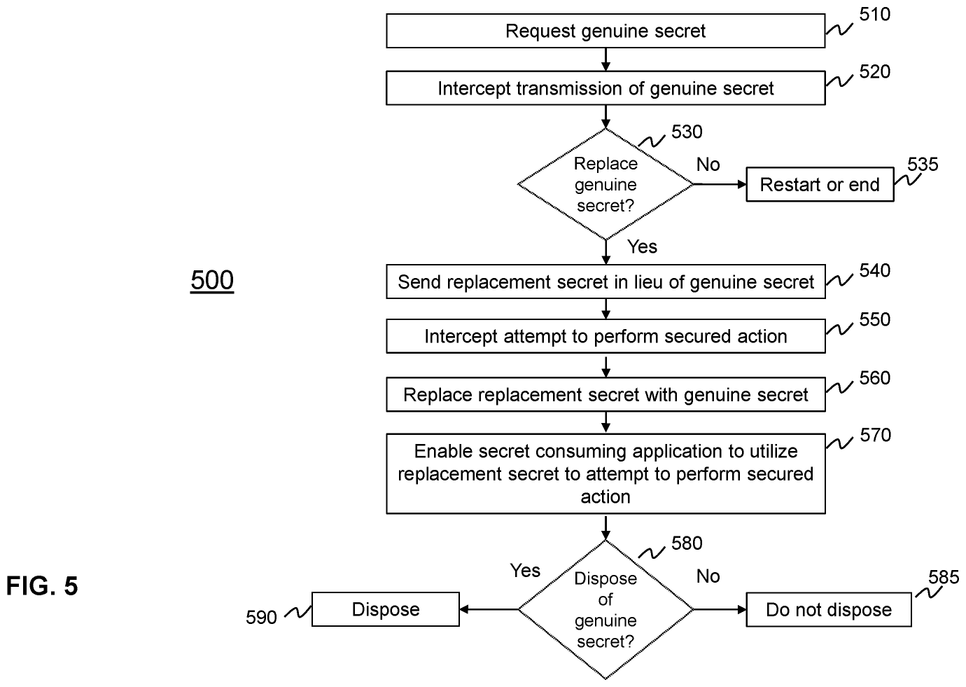

Server 410 further includes one or more storage devices 460, which may include memory 480 and physical storage 470 (e.g., hard drive, solid-state drive, etc.). Memory 480 may include random access memory (RAM) 482 and read-only memory (ROM) 484. Storage devices 460 maybe communicatively coupled with processors 130 and main processors 450 via bus 440. Storage devices 460 may include a main memory, which can be used for storing temporary variables or other intermediate information during execution of instructions to be executed by processors 130 and main processors 450. Such instructions, e.g., those as discussed below in connection with FIG. 5, after being stored in non-transitory storage media accessible to processors 130 and main processors 450, render server 410 into a special-purpose machine that is customized to perform operations specified in the instructions. The term “non-transitory media” as used herein refers to any non-transitory media storing data or instructions that cause a machine to operate in a specific fashion (e.g., in accordance with FIG. 5, below). Such non-transitory media can include non-volatile media or volatile media. Non-transitory media include, for example, optical or magnetic disks, dynamic memory, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, flash memory, register, cache, any other memory chip or cartridge, and networked versions of the same.

Various forms of media can be involved in carrying one or more sequences of one or more instructions to processors 130 or main processors 450 for execution. For example, the instructions can initially be carried out on a magnetic disk or solid-state drive of a remote computer. The remote computer can load the instructions into its dynamic memory and send the instructions over a telephone line using a modem. A modem local to server 410 can receive the data and use an infra-red transmitter to convert the data to an infra-red signal. An infrared detector can receive the data carried in the infrared signal, and appropriate circuitry can place the data on bus 440. Bus 440 carries the data to the main memory within storage devices 460, from which processors 130 or main processors 450 retrieves and executes the instructions.

Secret replacement system 200 (as shown in FIG. 2) or one or more of its components may reside on either server 310 or 410 and may be executed by processors 130 or 450. Similarly, secure web browser 230 and secret consuming application 260 may be implemented in accordance with the architecture of either server 310 or 420.

User interface 114 and computer 110 may communicate with server 310 or 410 through network 120. For example, server 310 or 410 may be a server configured to store files accessible through a network (e.g., a web server, application server, virtualized server, etc.). Server 310 or 410 may be implemented as a Software as a Service (SaaS) platform through which software for auditing recorded user activity may be provided to an organization as a web-based service.

FIG. 5 is a flowchart showing an example process for replacing secrets for use with browser components, consistent with disclosed embodiments. Process 500 may be performed by at least one processing device of a server (e.g., server 310 or 410), via a processor such as processor 130, as described above. In some embodiments, a non-transitory computer readable medium may contain instructions that when executed by a processor cause the processor to perform process 500. Further, process 500 is not necessarily limited to the steps shown in FIG. 5 and any steps or processes of the various embodiments described throughout the present disclosure may also be included in process 500.

In step 510, process 500 may include requesting, by a secret management application running in conjunction with a browser component, a genuine secret. In some embodiments, the secret management application may be a cloud-based engine. The browser component may be a browser component as described with respect to FIG. 1 and the genuine secret may be a genuine secret as described with respect to FIG. 2. In some embodiments, the request for the genuine secret may come from a component other than the secret management application. For example, the request may come from the initiation of an application, an automated trigger, a time of day, a request from another application, etc.

In step 520, a transmission (or attempted transmission) of the genuine secret may be intercepted. For example, if the genuine secret 220 is transmitted (or attempted to be transmitted) from secret management application 210 to secure web browser 230 or another application, the genuine secret 220 may be intercepted. The interception may be performed, for example, by secret replacement module 250 or another application or agent. In some embodiments, the interception is performed based on a determination that the genuine secret 220 should be replaced. In further embodiments, the interception is based on a determination that the genuine secret 220 is being sent in a message addressed to secure web browser 230 (or another application or agent). In other embodiments, the interception may be based on a determination by secret management application 210 itself that the genuine secret 220 should be sent to secret replacement module 250 and not to secure web browser 230. Other techniques for intercepting genuine secret 220 are possible as well.

In step 530, process 500 may determine whether to replace the genuine secret, consistent with disclosed embodiments. Replacing the genuine secret 220 may be determined by any number of factors, as described with respect to FIGS. 1 and 2 above. As discussed above, such factors may be rules or policies implemented at secret replacement module 250 or at secret management application 210. Such rules or policies may be based on the identity of secure web browser 230, a requested action by secure web browser 230, an action history or behavioral history of secure web browser 230, a request by secure web browser 230 to access secret consuming application 260, a time of day, a geographic location, and various others. Based on the determination at step 530, process 500 may determine to not replace the genuine secret at step 535. For example, process 500 may determine not to replace the genuine secret if it determines that the request for a genuine secret at step 510 was malicious, or if process 500 determines that the request was a duplicative request. Similarly, if it is determined in step 530 that the genuine secret 220 has expired, is invalid, or is compromised, it may be determined not to replace it and thus proceed to step 535. Further, if it is determined in step 530 that the requested action (e.g., secure web browser 230 seeking access to a target resource) does not require the genuine secret 220, it may not be necessary to replace the secret. In step 535, the method 500 may end or restart back at steps 510 or 520 (e.g., wait for a future request for a genuine secret or interception of a genuine secret). If process 500 determines that it should replace the genuine secret at step 530, process 530 will proceed to step 540.

In step 540, process 500 may include sending, to a secret consuming application or to a secure web browser, a replacement secret in lieu of the genuine secret. As discussed above, the replacement secret may be provided from a secret replacement module 250 that has determined the genuine secret 220 should be replaced and has intercepted a transmission of the genuine secret 220 from the secret management application 210 to the secret consuming application 260 or to the secure web browser 230. In some embodiments, the secret consuming application 260 or secure web browser 230 may be (or utilize) an operating system application with a secret-based operation. The secret consuming application 260, for example, may require a secret before it can proceed with an action, such as authorization or authentication. In some embodiments, the interception occurs before the genuine secret 220 is sent to the secret consuming application 260 to replace the genuine secret 220. As discussed above, the genuine secret 220 may be different from the replacement secret. Both may be equivalent in certain respects (e.g., character length, bit length, equivalency in certain beginning or ending values, same encryption format, etc.). In some embodiments, the interception of the genuine secret 220 occurs between the secret management application 210 and the secure web browser 230 (e.g., by the secret replacement module 250). The interception may also be performed by a browser component such as an extension, agent, web password manager, or the like.

In some embodiments, the secret replacement module 250 is configured to store secrets in a protected manner. In some embodiments, the protected manner may be a protected memory region (e.g., an encrypted or access-restricted memory). The protected memory may be a way to control memory access rights on a computer or network based on the instruction set architecture and operating system. The protected memory may prevent access to memory that has not been allocated. This may prevent a bug or malware from affecting other processes or the operating system. Protection may include some or all access to a specific area of memory, write accesses, or attempts to execute the contents of the protected memory region. In some embodiments, the protected manner is controlled by an external service or application. For example, a dedicated software agent executed on the endpoint, such as CyberArk's Endpoint Privilege Manager (EPM)™ may enforce the organization's security policy to block and contain attacks on endpoint computers or may enforce an organizational policy ensuring that a user or an entity may only have access to the specific data, resources, and applications needed to complete a required task (known as the principle of least-privilege). Protected storage embodiments may include a memory region protected by encryption, obfuscation, hardening, or the like. For example, encryption may occur using asymmetric encryption (public key encryption). Obfuscation may comprise hiding valuable information contained in code. Hardening may comprise practices to optimize security practices, such as limiting remote access.

In some embodiments, the secret replacement module 250 is configured to operate according to one or more configuration parameters to determine whether to replace the genuine secret 220, as discussed above. In some embodiments, the configuration parameters may include at least one of a definition of the secured action (e.g., request, read, write, modify, etc.), a network resource name (e.g., IP address, URL, MAC address, file path, etc.), a network resource address of a resource that performs the secured action, or a time expiration parameter associated with the genuine secret. In some embodiments the configuration parameters include at least one of a file type, a file name, a file signature, a file path, or a file checksum, typical of an operating system application. A file type defines how files and organizational data are stored in a computer. A file name may be used to uniquely identify a computer file in a file system. A file signature may be a specific sequence of bytes in a file enabling programs to identify the file type without relying on a file extension. A file signature can help computer programs read a file when its extension has been changed or misidentified. A file path may specify the location of a file in a computer's file system. The file path can be used to locate files and web resources. A file checksum may be a string of numbers and letters used to check whether data or a file has been altered during storage or transmission. In some embodiments, these parameters are associated with a web application. In some embodiments, the secured action includes accessing an access-restricted network location or application (e.g., secret consuming application 260).

In some embodiments, the secret management application 210 is integrated into the web browser component, as described with respect to FIG. 1. In some embodiments, the request by the secret management application 210 prompts the browser component to make a corresponding request for the genuine secret 220. In some embodiments, the request is required to proceed with the secured action. In other embodiments, the secret management application is a module distinct from the browser component. In some embodiments, the browser component is a part of a web browser, as described with respect to FIG. 1. In some embodiments, the browser component is a web browser plug-in. The plug-in may be a software component that users can install to handle content the browser cannot support natively.

In step 540, process 500 may send the replacement secret 240 in lieu of the genuine secret 220 to secure web browser 230 or to secret consuming application 260. Process 500 may send the replacement secret 240 from secret management application 210, as described with respect to FIG. 2. Process 500 may send the replacement secret 240 immediately or may send the replacement secret 240 after a predetermined period of time. In some embodiments, process 500 may send the replacement secret 240 using secret replacement module 250 itself, as described with respect to FIG. 2.

In step 550, process 500 may intercept an attempt to perform a secured action. In some embodiments, the secured action may be one of login, authentication, authorization, approval, access, control, etc., as discussed above. In some embodiments, secret replacement module 250 intercepts a transmission of the genuine secret 220 from the secret management application 210 to the secret consuming application 260 before the secured action is performed. In some embodiments, the interception may occur because secret replacement module 250 identifies an action that requires a replacement secret 240. In some embodiments, the interception may occur because process 500 identifies an action or requested action as potentially malicious.

In step 560, process 500 may replace the replacement secret 240 with the genuine secret 220. In some embodiments, replacing the replacement secret 240 with the genuine secret 220 allows the application (e.g., secret consuming application 260) to perform the secured action. In some embodiments, the replacement may occur at secret replacement module 250 itself or at secret management application 210. In some embodiments, the replacement may occur by using a one-time genuine secret, a limited-use genuine secret, or an otherwise limited use secret. Alternatively, the genuine secret may have no usage limitations.

In step 570, process 500 may include enabling the secret consuming application to utilize the replacement secret to attempt to perform a secured action. As discussed above, the secret replacement module 250 may intercept an attempt to perform a secured action and replace the replacement secret 240 with the genuine secret 220 to complete the attempt. The secured action may be, as discussed above, one of login, authentication, authorization, approval, access, control, etc. In some embodiments, the secret replacement module 250 is configured to store the genuine secret 220 in a protected manner.

In some embodiments, the secret replacement module 250 is configured to dispose of the genuine secret 220 in step 580. For example, the decision in step 580 may be based on at least one of a time parameter or a usage parameter for the genuine secret 220. Further, the decision in step 580 may be based on whether the genuine secret 220 has been decommissioned (e.g., invalidated, rotated, compromised, or otherwise nullified). For example, the time parameter may be an expiration parameter related to a certain period of time. The usage parameter may regulate usage of the genuine secret. For example, if the genuine secret is used, it may expire.

In some embodiments, the secret replacement module is configured to generate the replacement secret on a just-in-time basis. For example, the replacement secret 240 may be generated following (not before) a request for access to secret consuming application 260. Further, some just-in-time techniques may involve intercepting a request for the genuine secret 220 or a transfer of genuine secret 220 to secure web browser 230, and generating the replacement secret 240 based on such events. In some embodiments, the secret replacement module 250 is configured to generate the replacement secret 240 according to a least-privilege principle. The least-privilege principle may dictate that a user or entity may only access specific data, resources, or applications needed to complete a required task, such as a secured action, and shall not have any excess privileges (in scope or duration). In some embodiments, the secret replacement module 250 is configured to decommission the replacement secret when the replacement secret is no longer necessary. If in step 580 it is determined that the genuine secret 220 should be replaced, process 500 proceeds to step 590 and the genuine secret 220 is disposed of or decommissioned (e.g., deleted, rotated, nullified, replaced, etc.). Alternatively, in step 585 the genuine secret 220 may not be disposed of or decommissioned, and may potentially continue to be used.

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways.

The disclosed embodiments may be implemented in a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant virtualization platforms, virtualization platform environments, trusted cloud platform resources, cloud-based assets, protocols, communication networks, security tokens and authentication credentials, and code types will be developed, and the scope of these terms is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A non-transitory computer readable medium including instructions that, when executed by at least one processor, cause the at least one processor to perform operations for replacing secrets for use with browser components, the operations comprising:
requesting, by a secret management application running in conjunction with a browser component, a genuine secret;
sending, to a secret consuming application, a replacement secret in lieu of the genuine secret, wherein the replacement secret is provided from a secret replacement module that has determined that the genuine secret should be replaced and has intercepted a transmission of the genuine secret from the secret management application to the secret consuming application; and
enabling the secret consuming application to utilize the replacement secret to attempt to perform a secured action, wherein the secret replacement module intercepts the attempt and replaces the replacement secret with the genuine secret to complete the attempt.

2. The non-transitory computer readable medium of claim 1, wherein the secret replacement module is configured to store secrets in a protected manner associated with the browser component.

3. The non-transitory computer readable medium of claim 2, wherein the protected manner is controlled by an external service or application.

4. The non-transitory computer readable medium of claim 1, wherein the interception of the genuine secret occurs between the secret management application and the browser component.

5. The non-transitory computer readable medium of claim 1, wherein the secret replacement module is configured to operate according to one or more configuration parameters.

6. The non-transitory computer readable medium of claim 5, wherein the secret replacement module is configured to operate according to one or more configuration parameters to determine whether to replace the genuine secret.

7. The non-transitory computer readable medium of claim 4, wherein the one or more configuration parameters include at least one of: a definition of the secured action, a network resource name, a network resource address of a resource that performs the secured action, or an expiration parameter associated with the genuine secret.

8. The non-transitory computer readable medium of claim 7, wherein the secured action includes accessing an access-restricted network location.

9. The non-transitory computer readable medium of claim 4, wherein the one or more configuration parameters include at least one of: a file type, a file name, a file signature, a file path, or a file checksum.

10. The non-transitory computer readable medium of claim 9, wherein the secured action includes accessing an access-restricted application.

11. A computer-implemented method for replacing secrets for use with a browser component, the method comprising:
requesting, by a secret management application running in conjunction with a browser component, a genuine secret;
sending to a secret consuming application, a replacement secret in lieu of the genuine secret, wherein the replacement secret is provided from a secret replacement module that has determined that the genuine secret should be replaced and has intercepted a transmission of the genuine secret from the secret management application to the secret consuming application; and
enabling the secret consuming application to utilize the replacement secret to attempt to perform a secured action, wherein the secret replacement module intercepts the attempt and replaces the replacement secret with the genuine secret to enable the attempt.

12. The computer-implemented method of claim 11, wherein the secret management application is integrated into the browser component.

13. The computer-implemented method of claim 12, wherein the request by the secret management application prompts the browser component to make a corresponding request for the genuine secret.

14. The computer-implemented method of claim 11, wherein the secret management application is a module distinct from the browser component.

15. The computer-implemented method of claim 11, wherein the browser component is a part of a web browser.

16. The computer-implemented method of claim 11, wherein the browser component is a web browser plug-in.

17. The computer-implemented method of claim 11, wherein the secret replacement module is configured to store the genuine secret in a protected manner.

18. The computer-implemented method of claim 11, wherein the secret replacement module is configured to discard the genuine secret based on at least one of: a time parameter or a usage parameter.

19. The computer-implemented method of claim 11, wherein the secret replacement module is configured to generate the replacement secret on a just-in-time basis.

20. The computer-implemented method of claim 11, wherein the secret replacement module is configured to generate the replacement secret according to a least-privilege principle.

21. The computer-implemented method of claim 11, wherein the secret replacement module is configured to decommission the replacement secret when it is no longer necessary.
